(19) United States
(12) Patent Application Publication
(10) Pub. No.: US 2020/0077269 A1
(43) Pub. Date: Mar. 5, 2020

(54) METHOD FOR CONNECTING EQUIPMENT TO THE INTERNET NETWORK

(71) Applicant: Anas FAWZY, Paris (FR)

(72) Inventor: Anas FAWZY, Paris (FR)

(21) Appl. No.: 16/613,530

(22) PCT Filed: May 15, 2018
(86) PCT No.: PCT/FR2018/000120

§ 371 Date: Nov. 14, 2019

(30) Foreign Application Priority Data
May 15, 2017 (FR) 1754246

(51) Int. Cl. H04W 12/08; H04W 84/12; H04W 4/20; H04W 12/00

(52) U.S. Cl. CPC H04W 12/0806; H04W 84/12; H04W 12/0804; H04W 12/003; H04W 4/20

(57) ABSTRACT

A method for connecting equipment to the internet network using a “host” modem-router comprising a first “host” access point, including saving a table in a computer server, which table stores a list of unique identifiers associated with users; adding a “guest” router to the “host” modem-router that is provided with a second “guest” access point to the internet network, which “guest” access point is initially in a deactivated state, and, in order to connect at least one other “guest” item of equipment to the internet network.

### TECHNICAL FIELD OF THE INVENTION

The aim of the invention is a method for connecting equipment to the Internet network.

Notably, it relates to the technical field of telecommunications and more specifically techniques for coupling access accounts to the Internet network.

### PRIOR ART

A modem-router (generally known as “box”) is generally provided by an Internet network access provider to its subscribers. The “modem” has the main function of establishing and managing the connections between the local network of the subscriber, also known as the home network, towards the Internet network of the access provider and of converting (modulating/demodulating) the data flows into a protocol that can be used by the items of equipment of the subscriber (fixed or portable computer, tablet, Smartphone, television, home automation device, telephone line, etc.). The connections towards the network may be produced through optical fibers, microwave radio system, satellite communications system, or other.

The “router” makes it possible to create and name a wireless local computer network and share the connection of the modem with a plurality of items of equipment of the subscriber. The router has “Wireless Access Point” (Access Point) functions, that is to say it is adapted to generate a wireless home network (Wi-Fi, Bluetooth, etc.) to which the items of equipment of the subscriber will be able to connect. The access point is used as interface in order to authorize or not an item of equipment to access the Internet network via a home network. The items of equipment of the subscriber must generally be authenticated with the router in order to be able to connect thereto. For this, a security key, such as a WEP, WPA, or WPA2 key, is input through a user interface of the item of equipment and transmitted to the router in order to finalize the connection. Said security key, generally only known by the subscriber, prevents third-party equipment from unduly taking advantage of his home network.

Each subscriber is further holder of an Internet network access account, which account is attributed by the provider with which he is affiliated. Said access account brings into play a plurality of connection parameters adjusted in order to adapt the numerical data intended for or emitted by the items of equipment of the subscriber to the specific configuration of the Internet network of the provider and/or to a parametrization specific to said subscriber. Said connection parameters notably include a unique subscriber identifier (the equivalent of an IMSI (International Mobile Subscriber Identity) identifier), a private security key (WEP, WAP, WAP2 key, etc.) and optionally certain rights and/or restrictions open to the subscriber, for example, access rights to pay-per-view television channels, a parental control, a firewall, a landline telephone number, etc. Each subscriber therefore parametrizes his native modem-router with his own connection parameters. Each item of equipment of the subscriber can then connect to the native modem-router with the private security key and identify itself with said native modem-router with its MAC (Media Access Control) address.

By way of example, let us take the case where a subscriber A rents all or part of his dwelling premises to a subscriber B, said rental being, for example, carried out from a platform of the Airbnb® type. The subscriber B can only connect his items of equipment to the modem-router of the subscriber A if said latter communicates thereto his connection parameters and notably his private security key. Without said information, the subscriber B cannot access the Internet network via his items of equipment. The communication of said information has certain risks for the subscriber A, for example, in the case where the subscriber B exchanges sensitive data and/or visits prohibited Internet sites, since it is not possible to identify and track the data exchanges initiated by the subscriber B from same initiated by the subscriber A. Also, the subscriber A practically never communicates his connection parameters to the subscriber B, said latter then being deprived of Internet access. And even if the subscriber A communicates his connection parameters to the subscriber B, said latter will not be able to benefit from his own rights and/or restrictions (access rights to pay-per-view television channels, parental control, firewall, etc.).

Patent documents EP2871876 (ORANGE) and EP2337388 (FRANCE TELECOM) describe methods of secure access by a guest terminal to a host network. Patent document FR3000857 (VIRTUOR) relates to an access technique, by a computer user terminal, to a computer service provided through a communication network. More specifically, said document FR3000857 discloses the use of an access box wherein a virtual machine makes it possible to establish a connection with a remote server providing the computer service to an user terminal. Said access technique is relatively complex and expensive to implement notably insofar as it needs a specific access box that must manage virtual machines. Furthermore, the initial data exchanges and parametrization of virtual machines are produced from the access box. In order to use the aforementioned example, it therefore seems necessary that the subscriber A communicates beforehand his connection parameters to the subscriber B.

The invention aims to overcome this state of things. In particular, one aim of the invention is to be able to couple distinct accounts for accessing the Internet network by using a unique modem-router.

Another aim of the invention is to be able to couple said distinct accounts in a simple, reliable, automated, and secure manner.

An additional aim of the invention is to be able to identify and track the data exchanges associated with each of the distinct Internet network access accounts.

### DISCLOSURE OF THE INVENTION

The solution proposed by the invention is a method for connecting equipment to the Internet network using a modem-router, known as “host” modem-router, comprising a first access point, known as “host” access point, enabling at least one item of equipment paired to said “host” modem-router, known as “host” item of equipment, to connect to the Internet network with connection parameters, known as “host” connection parameters, specific to the user of the “host” item of equipment.

The method comprises prior steps of:
saving in a computer server accessible from the Internet network, a table wherein is stored a list of unique identifiers associated with users, which identifiers are associated with connection parameters specific to each user,
adding to the “host” modem-router a router, known as “guest” router, which “guest” router is provided with a second access point to the Internet network, known as “guest” access point”, which “guest” access point is initially in a deactivated state.
In order to connect at least one other item of equipment, known as “guest” item of equipment, to the Internet network, said method comprises subsequent steps of:
communicating, to the “guest” router, a unique identifier, known as “guest” identifier, associated with a user of the “guest” item of equipment,
transmitting to the computer server, from the “guest” router, the “guest” identifier, associated with a user of the “guest” item of equipment,
polling the table to verify that the “guest” identifier is stored in said table,
if the “guest” identifier is stored in the table: transmitting to the “guest” router, from the computer server:—an activation command of the “guest” access point;—and connection parameters, known as “guest” connection parameters, specific to the user of said “guest” item of equipment and that are associated with the “guest” identifier in the table,
activating the “guest” access point following the receipt of the activation command by the “guest” router,
pairing the “guest” item of equipment with the “guest” router, for the connection thereof to the Internet network through the “guest” access point and with connection parameters, known as “guest” connection parameters, specific to the user of said “guest” item of equipment,
saving the log of connections of the “guest” item of equipment performed through the “guest” router.

By using the aforementioned example, the subscriber A (the host) has his own native account and can continue to use same to access the Internet network of his provider. The subscriber B (the guest) can also connect to the Internet network, with his own connection parameters, while using the “host” modem-router, without the subscriber A having to communicate thereto his connection parameters. Therefore, the Internet network access accounts of the subscriber A and of the subscriber B can be coupled, by using a unique modem provided with two dedicated routers. The connections of the subscriber B are nevertheless tracked and/or isolated from the connections of the subscriber A.

Other advantageous features of the invention are listed hereinbelow. Each one of these features can be considered individually or combined with the remarkable features defined hereinabove, and may be the subject matter, where applicable, of one or more divisional patent applications:
It is possible to associate in the table, the unique identifiers with connection parameters specific to each user; then transmit to the “guest” router, from the computer server, apart from the activation command of the “guest” access point, the “guest” connection parameters, and parametrize the “guest” router with the “guest” connection parameters transmitted by the computer server.
The “guest” router may be directly integrated into the “host” modem-router.
According to an alternative embodiment, the “guest” router is moved away from the physical media device of the “host” modem-router, a connection between said “guest” router and said modem-router being established so that said “host” modem-router acts as a repeater.
Advantageously, the method comprises a step of establishing a wireless connection between the “guest” router and the “host” modem-router so that said “guest” router and said “host” modem-router communicate through the “host” access point.
The method may comprise a step of transmitting to the “guest” router a private security key associated with the “host” access point, known as “host” private security key, in order to authorize said “guest” router to communicate with the “host” modem-router through the “host” access point.
The method may comprise a step of establishing a wired connection between the “guest” router and the “host” modem-router so that said “guest” router and said “host” modem-router communicate through said wired connection.
Advantageously, the stopping of the connection between the “guest” router and the “host” modem-router results in the automatic implementation of a logical computer process leading to the deactivation of the “guest” access point.
The method may comprise steps of:—saving in a secure removable media device the “guest” unique identifier;—equipping the modem-router with a connection interface adapted to receive the secure removable media device.
Advantageously, the insertion of the secure removable media device into the connection interface results in the automatic transmission of the “guest” unique identifier to the computer server.
Advantageously, the withdrawal of the secure removable media device from the connection interface results in the automatic implementation of a logical computer process leading to the deactivation of the “guest” access point.
The method may comprise steps of:—saving in the secure removable media device, apart from the “guest” identifier, the “guest” connection parameters;—parametrizing the “guest” router with the “guest” connection parameters following the insertion of the secure removable media device into the connection interface, which parametrization is performed before, during or after the activation of the “guest” access point.
The method may comprise a step of saving in the computer server the log of connections of the “guest” item of equipment performed through the “guest” router.
The method may comprise steps of:—integrating in the activation command at least one of the following parametrization data: duration of the activation of the “guest” access point, portion of bandwidth allocated to the “guest” access point;—automatically parametrizing the “guest” router with the item or items of parametrization data integrated into the activation command.

### DESCRIPTION OF THE FIGURES

Other advantages and features of the invention shall appear better when reading the following description of a preferred embodiment, in reference to the attached drawings, provided as non-limiting examples for the purpose of information and wherein:

FIG. 1 schematizes a system for the implementation of the method of the invention, according to a first embodiment,

FIG. 2 schematizes the arrangement of various components of the “host” modem-router and of the “guest” router illustrated in FIG. 1,

FIG. 3 schematizes the arrangement of various components of a computer server used for the implementation of the method subject matter of the invention,

FIG. 4 illustrates various steps implemented in the method subject matter of the invention, with the system illustrated in FIG. 1,

FIG. 5 schematizes a system for the implementation of the method of the invention, according to a second embodiment and a first alternative,

FIG. 6 schematizes the arrangement of various components of the “guest” modem-router illustrated in FIG. 5,

FIG. 7 schematizes a system for the implementation of the method of the invention, according to a second embodiment and a second alternative,

FIG. 8 illustrates various steps implemented in the method subject matter of the invention, with the system illustrated in FIGS. 5 and 7.

### PREFERRED EMBODIMENTS OF THE INVENTION

The method subject matter of the invention consists of a coherent sequence of steps for achieving a desired result. These steps result in the handling of physical elements, notably signals (electric or magnetic) capable of being stored, transferred, combined, compared, etc.

The method is implemented through the intermediary of computer applications run by computer devices. In the interest of clarity, it should be understood within the meaning of the invention that “the device does something” means “the computer application run by the processor or microprocessor of the device does something”. Just like “the computer application does something” means “the computer application run by the processor or microprocessor of the device does something”.

Again, in the interest of clarity, the present invention makes reference to one or more “logical computer processes”. Said latter correspond to the actions or results obtained by the running of instructions of various computer applications. Also, it should also be understood within the meaning of the invention that “a logical computer process does something” means “the instructions of one or more computer applications run by one or more processors or microprocessors do something”.

In order to follow the aforementioned example, the subscriber A (or host user) being the person who invites or rents his dwelling to the subscriber B, the term “host” will be associated with all of the elements and items of equipment specific to the subscriber A. Similarly, the term “guest” will be associated with all of the elements and items of equipment specific to the subscriber B (or guest user).

### First Embodiment

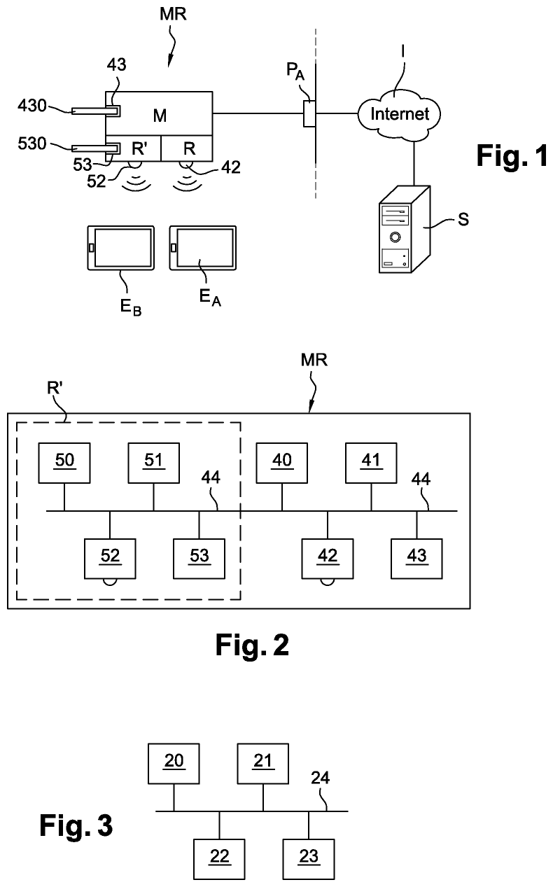

By referring to FIG. 1, a system for the implementation of the method subject matter of the invention comprises a “host” modem-router MR. Said latter conventionally integrates a modem M and a router R and is presented in the form of a conventional Internet box, for example, of the Livebox® or Freebox® type. In order to use the aforementioned example, the “host” modem-router belongs to the host and is installed inside the dwelling of said latter. The “host” modem-router MR is notably connected to the terminating point P_{A} of the dwelling of the host, by means of a wired link, for example, a cable with T-plug.

The “host” modem-router is initially parametrized with the connection parameters of the account for accessing the Internet network I of the host. Said connection parameters notably include the unique identifier of the host, an item of identification data of the Internet access provider of the host (which indication may be included in the unique identifier), a “host” private security key (e.g.: WEP, WAP or WAP2 key) and optionally certain rights and/or restrictions open to the host (e.g.: access rights to pay-per-view television channels, parental control, firewall, landline telephone number, etc.).

By referring to FIG. 2, the “host” modem-router MR notably comprises one or more processors or microprocessors 40, one or more memories 41, a network interface 42—or access point, optionally a connection interface 43 for smart card, SIM card, or USB stick, which are mutually connected via a bus 44. One or more computer applications—or computer programs—are saved in the memory or memories 41 and the instructions of which, when they are run by the processor or processors 40 make it possible to produce the functions described above in the description.

The memory or memories 41 must be considered as a storage device also adapted to store data and/or data files. It may concern a native memory or an add-on memory such as a Secure Digital (SD) card. The MAC address of the “host” modem-router is saved in the memory 41, said MAC address being unique is pre-saved in the factory.

The “host” access point 42 is a wired or wireless communication interface adapted to establish a communication with the “host” items of equipment E_{A} (fixed or portable computer, tablet, Smartphone, television, telephone line, etc.), by using notably the “host” private security key (WEP, WAP, WAP2 key, etc.). The “host” access point may, for example, comprise a Wi-Fi transmitter/receiver, an Ethernet connection, a PLC (Power-line Communication) connection, a Bluetooth module, or any other means capable of establishing a connection to the “host” items of equipment E_{A}. In general, the “host” access point 42 has the function of managing the connections between the “host” modem-router and the “host” items of equipment E_{A}. After having paired same to the “host” modem-router, the “host” items of equipment thus connect to the Internet network I through the “host” access point and with “host” connection parameters.

The connection interface 43 is adapted to receive a secure removable media device 430 (smart card, SIM card, or USB stick) wherein are saved numerical data. In practice, said numerical data contain the connection parameters of the host. Said connection interface 43 is optional.

The system in FIG. 1 comprises a “guest” router R′, directly integrated into the “host” modem-router. By referring to FIG. 2, said “guest” router R′ notably comprises one or more processors or microprocessors 50, one or more memories 51, a network interface 52—or access point, optionally a connection interface 53 for smart card, SIM card, or USB stick, which are mutually connected via the bus 44. One or more computer applications—or computer programs—are saved in the memory or memories 51 and the instructions of which, when they are run by the processor or processors 50 make it possible to produce the functions described above in the description.

The memory or memories 51 must be considered as a storage device also adapted to store data and/or data files. It may concern a native memory or an add-on memory such as a Secure Digital (SD) card. The memory 51 may be the same as the aforementioned memory 41. Similarly, the processor 40 or 50 may be common to the “host” modem-router and to the “guest” router.

The “guest” access point 52 is a wired or wireless communication interface adapted to establish a communication with the “guest” items of equipment E_{B} of the guest (fixed or portable computer, tablet, Smartphone, television, telephone line, etc.), by using notably a “guest” private security key (WEP, WAP, WAP2 key, etc.). The “guest” access point may, for example, comprise a Wi-Fi transmitter/receiver, an Ethernet connection, a PLC (Power-line Communication) connection, a Bluetooth module, or any other means capable of establishing a connection to the “guest” items of equipment E_{B}. In general, the “guest” access point 52 has the function of managing the connections between the modem-router MR and the “guest” items of equipment E_{B}.

The connection interface 53 is adapted to receive a secure removable media device 530 wherein are saved numerical data containing the connection parameters of the guest. Said connection interface 53 is optional. The secure removable media device 530 may be in the form of a smart card, SIM (Subscriber Identity Module) card, SD (Secure Digital) card or USB (Universal Serial Bus) stick.

The system in FIG. 1 also comprises a remote computer server S accessible from the Internet network I. The server S is remote from the dwelling of the host and may consist of a physical server or, in some cases, be composed of a plurality of distinct computers that communicate and interact over a network in order to run the functions described above.

By referring to FIG. 3, the remote server S notably comprises one or more processors or microprocessors 20, one or more memories 21, a network interface 22, a database 23, which are mutually connected via a bus 24. One or more computer applications—or computer programs—are saved in the memory or memories 21 and the instructions of which, when they are run by the processor or processors 20 make it possible to produce the functions described above in the description.

The network interface 22 is a wired or wireless communication interface adapted to establish a communication with the Internet network I. The network interface 22 notably enables the server S to exchange signals or data with the “host” modem-router.

The database 23 may be hosted directly in the server S, or in another server or in a network of Cloud Computing type servers, or in a computer, or in a Smartphone.

A computer application is installed in the remote server S in order to implement all or part of the invention from said server as explained earlier in the description. Said computer application may be pre-installed on the remote server S or be downloaded later.

In the database 23 is saved a table wherein is stored a list of unique identifiers associated with users. Each user, and notably the guest, is registered beforehand with the server S so that said latter assigns thereto a unique identifier, which is, for example, in the form of an alphanumerical code or in the form of an IMSI (International Mobile Subscriber Identity) identifier. The guest (and more generally each user) can, for example, connect to the server S via the Internet network I by using his Smartphone, his tablet, his fixed or portable computer. Once connected to the server S, he accesses a graphic interface that enables him to register by identifying himself (name, first name, birth date, address, etc.). He may also be required to enter his connection parameters (identification data of his Internet access provider, name of the network, private security key such as WEP, WAP or WAP2 key, and optionally certain rights and/or restrictions such as access rights to pay-per-view television channels, parental control, firewall, landline telephone number, etc.). When the registration process is finalized, the server S generates the unique identifier and communicates same to the guest. The table saved in the database 23 thus stores the list of all of the unique identifiers associated with users and associated, if applicable, with the connection parameters specific to each user.

The “guest” unique identifier generated by the server S may be saved in the secure removable media device 530. The managing entity of the server S then provides said pre-parametrized media device to the guest (for example, by sending same by post). The pre-parametrized secure removable media device 530 may also contain the “guest” connection parameters entered at the time of the registration. The server S may also transmit the “guest” unique identifier (and optionally the “guest” connection parameters) to the item of equipment of the guest with which he is registered with said server.

In accordance with the invention, the “guest” access point 52 is in an initial deactivated state, that is to say it cannot be used by the guest. Said latter cannot connect his “guest” items of equipment to the “guest” access point, and therefore to the Internet network I, without an identification logical computer process having been implemented beforehand.

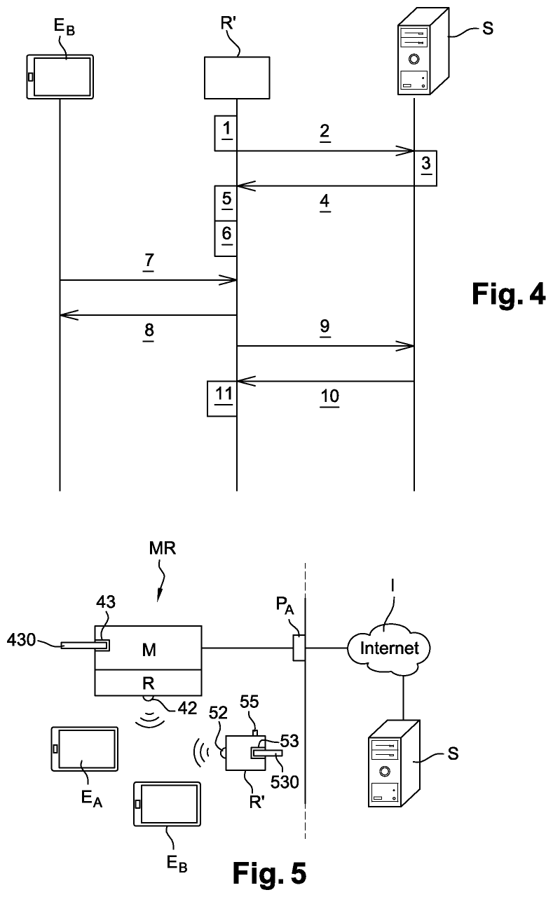

Said logical identification process is now described in reference to FIG. 4 which illustrates various steps implemented in the method subject matter of the invention.
Event 1: The “guest” unique identifier is communicated to the “guest” router R′. In the case where said “guest” unique identifier is saved beforehand in the secure removable media device 530, the guest simply inserts said media device into the connection interface 53 so that said communication takes place automatically. If the “guest” connection parameters are saved in the secure removable media device 530, said parameters are also communicated to the “guest” router at the same time as the “guest” unique identifier. In the case where the “guest” unique identifier is saved beforehand in an item of equipment of the guest having used his registration with the server S, the communication of said identifier to the “guest” router may be produced in near field, for example, by using the NFC (Near Field Communication) or RFID (Radio Frequency Identification) technology. If the “guest” connection parameters are saved in the item of equipment of the guest, said parameters are also communicated to the “guest” router at the same time as the “guest” unique identifier. The item of equipment of the guest and the “guest” router are in said latter case equipped with electronic equipment providing the implementation of said type of wireless communication.
Step 2: The “guest” router automatically generates and transmits an authentication request to the server S. The communication of the “guest” unique identifier to the server S is the element triggering the generation and transmission of the authentication request. Said authentication request is transmitted through the Internet network I, via the “host” modem-router. Said authentication request contains the “guest” unique identifier and, if applicable, the “guest” connection parameters.
Event 3: The server S polls the table saved in the database 23 in order to verify that the “guest” identifier received is indeed stored in said table. The receipt of the authentication request by the server S is the triggering element of said polling. If applicable, the server S may also verify that the “guest” connection parameters correspond indeed to same stored in the table.
Step 4: If the “guest” identifier is stored in the table, the server S generates and transmits to the “guest” router an activation command of the “guest” access point. In the opposite case, the activation command is neither generated nor transmitted to the “guest” router. The server S thus acts as trusted third party. If the verification is positive, the server S may also transmit to the “guest” router, apart from the activation command, the “guest” connection parameters stored in the table.
Event 5: The “guest” router activates the “guest” access point. The receipt of the activation command by the “guest” router is the triggering element of said activation. The success of the activation of the “guest” access point may, for example, be indicated by an audible or visual signal emitted from the “guest” router or from the “host” modem-router.
Event 6: The “guest” router is automatically parametrized with the “guest” connection parameters saved in the secure removable media device 530 and/or transmitted with the activation command in Step 4. In the example in FIG. 4, said parametrization is performed after Event 5, that is to say after the activation of the “guest” access point. Nevertheless, Event 6 may occur simultaneously with Event 5 (that is to say during the activation of the “guest” access point) or simultaneously with Event 1 (that is to say before the activation of the “guest” access point, following the insertion of the secure removable media device 530 into the connection interface 53).
Step 7: The “guest” item of equipment E_{B}, generates and transmits to the “guest” router a pairing request. The activation of the “guest” access point is the element triggering the generation and transmission of the pairing request. Said pairing request notably contains the “guest” private security key (WEP, WAP, WAP2 key, etc.). Said “guest” security key is preferably the same key that is used by the guest, in his own home network (notably in his own dwelling), when he connects his items of equipment to the modem-router that has been provided thereto by his own Internet network access provider. In practice, the “guest” item of equipment initiates beforehand a phase for discovering all of the access points activated nearby. Indeed, when same is activated, the “guest” access point periodically emits a frame containing a marker making it possible to identify same among the other access points of the network, and notably among the “host” access point. Once said discovery phase has been performed, the “guest” item of equipment or the guest chooses the “guest” access point to which he wants to connect among the list of access points discovered. Said procedure may be automatic. Then starts an exchange between the “guest” item of equipment and the “guest” access point chosen, wherein the “guest” access point requests from the “guest” item of equipment the corresponding “guest” security key that the “guest” item of equipment or the guest will have acquired beforehand with his Internet network access provider or with the server S. For example, in Step 4, the server S may communicate to the guest the “guest” security key by sending an SMS (Short Message Service) towards a telephone number that the guest will have entered beforehand at the time of his registration. The “guest” security key may also be visibly registered on the secure removable media device 530. If the “guest” security key is already saved in the “guest” item of equipment, the pairing is immediate. In the opposite case, the guest may be required to input beforehand the “guest” security key via a graphic interface of the “guest” item of equipment.
Step 8: If the pairing is confirmed, the “guest” router generates and transmits to the “guest” item of equipment a connection authorization signal. The “guest” item of equipment can then connect to the Internet network I, through the “guest” access point and with the “guest” connection parameters with which the “guest” router is parametrized. The guest may therefore access the Internet network, via the “host” modem-router, with his own “guest” connection parameters and without the host having had to communicate thereto his “host” private security key. And the host can therefore continue to access the Internet network, via the “host” access point, and with his own “host” connection parameters.
Step 9: When the secure removable media device 530 is withdrawn from the connection interface 53, a disconnection signal is transmitted to the server S. The withdrawal of the secure removable media device 530 is therefore the element triggering the generation and transmission of the disconnection signal. The “guest” router or the “host” modem-router may, for example, automatically generate and emit said disconnection signal. The server S may also poll the “guest” router by periodically transmitting thereto presence requests (“is the secure removable media device 530 present in the connection interface 53?”). While the “guest” router responds positively to said requests, the server S deduces that the secure removable media device 530 is indeed inserted into the connection interface 53. And in the absence of response, the server S deduces that the secure removable media device 530 is withdrawn from the connection interface 53. In another alternative embodiment, it is the “guest” router that periodically transmits to the server S presence messages (“the secure removable media device 530 is inserted into the connection interface 53”). While the server S receives said messages, same deduces that the secure removable media device 530 is indeed inserted into the connection interface 53. And in the absence of receipt of said messages, the server S deduces that the secure removable media device 530 is withdrawn from the connection interface 53.
Step 10: When the server S is informed of the withdrawal of the secure removable media device 530, it generates and transmits to the “guest” router a deactivation command of the “guest” access point.
Event 11: The “guest” router deactivates the “guest” access point. The receipt of the deactivation command by the “guest” router is the triggering element of said deactivation.

The deactivation of the “guest” access point may, for example, be indicated by an audible or visual signal emitted from the “guest” router or from the “host” modem-router.

It will be noted that in said first embodiment, the guest simply needs to transport the secure removable media device 530, the overall size of which is reduced, in order to activate the “guest” access point and connect his items of equipment E_{B} with his “guest” connection parameters.

### Second Embodiment

In the alternative embodiment illustrated in FIGS. 5 and 7, the “guest” router R′ is moved away from the physical media device of the “host” modem-router MR. This solution has the advantage, for the host of keeping his native modem-router MR, notably in the case where same only comprises a single access point 42. The “host” modem-router is initially parametrized with the connection parameters of the account for accessing the Internet network I of the host. It integrates the same components as same described previously in reference to FIG. 2.

The “guest” router R′ may be in the form of a box of relatively reduced dimensions, having, at most, the overall size of an Internet box. The “guest” router may be acquired by the host or by the guest, who must transport same up to the dwelling of the host.

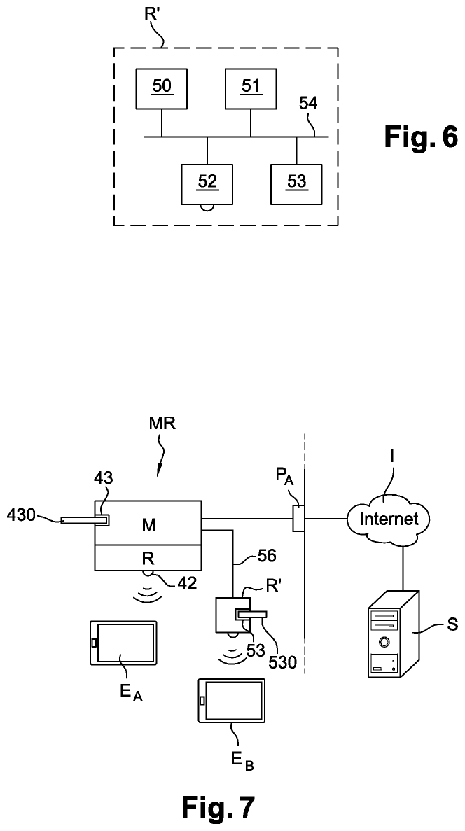

By referring to FIG. 6, said “guest” router R′ notably comprises one or more processors or microprocessors 50, one or more memories 51, an access point 52, optionally a connection interface 53, which are mutually connected via a bus 54. One or more computer applications—or computer programs—are saved in the memory or memories 51 and the instructions of which, when they are run by the processor or processors 50 make it possible to produce the functions described above in the description. Said components 50, 51, 52, 53 are similar to same described previously in reference to FIG. 2.

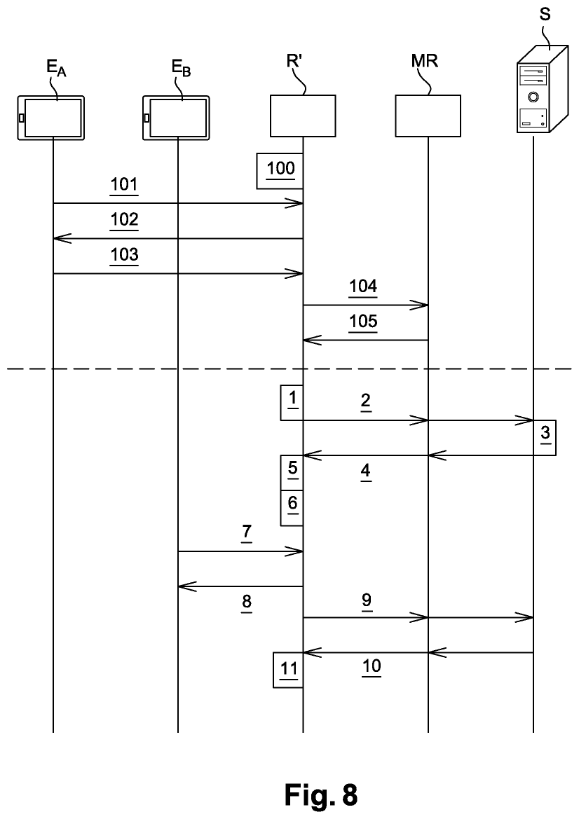

The “guest” access point 52 is in an initial deactivated state. The logical process leading to the activation thereof will now be described in reference to FIG. 8 which illustrates various steps implemented in the method subject matter of the invention.

The first phase of the activation logical process consists of establishing a connection between the “guest” router and the “host” modem-router.

### Second Embodiment—First Alternative Embodiment

In the system in FIG. 5, said connection is a wireless connection produced through the “host” access point 42. So that the “guest” router can connect to the “host” access point 42, it is necessary that said router knows the “host” private security key. The connection phase is preferably produced in the following manner (FIG. 8):
Event 100: The host manually activates a dedicated key 55, for example, a pushbutton, installed in an accessible manner on the box of the “guest” router R′. The activation of said dedicated key results in the opening of a temporary free session (Wi-Fi Hot Spot type) that momentarily activates (for example for 1 minute) the “guest” access point 52 and that makes a connection possible without private security key.
Step 101: The “host” item of equipment E_{A}, generates and transmits to the “guest” router a pairing request. In practice, the “host” item of equipment initiates a preliminary phase for discovering all of the access points activated nearby. The “guest” access point periodically emits a frame containing a marker making it possible to identify same among the other access points of the network, and notably among the “host” access point. The “host” item of equipment where the host chooses the “guest” access point to which he wants to connect. Once said selection has been performed, given that no “guest” security key is required, the “host” item of equipment is automatically paired with the “guest” router.
Step 102: As soon as the pairing is confirmed, the “guest” router generates and transmits to the “host” item of equipment a connection authorization signal. The “host” item of equipment can then connect to the “guest” router, through the “guest” access point.
Step 103: The host accesses, through the intermediary of his “host” item of equipment, a HTML (HyperText Markup Language) page locally integrated into the “guest” router. Said HTML page is displayed on the screen of the “host” item of equipment and serves as administrator control console. The host may then enter the public name of his “host” modem-router, the “host” private security key and optionally parametrization data such as duration of the activation of the “guest” access point and/or portion of bandwidth allocated to said “guest” access point. The host has thus transmitted securely and confidentially his “host” private security key to the “guest” router without the guest having knowledge thereof.
Step 104: The “guest” router generates and transmits to the “host” modem-router MR, a pairing request. The receipt of the “host” private security key and optionally of the parametrization data, by the “guest” router, is the element triggering the generation and transmission of the pairing request. Said pairing request notably contains the “host” private security key. In practice, it is the host who, from the administrator control console, selects the “host” access point and enters the “host” private security key required. Also, Step 104 may be performed simultaneously with Step 103.
Step 105: If the pairing is confirmed, the “host” modem-router generates and transmits to the “guest” router a connection authorization signal. The “guest” router can then connect to the Internet network I, through the “host” access point. When the connection phase between the “guest” router and the “host” modem-router is completed, the logical identification process described previously in reference to FIG. 4 (Event 1-Event 11), may then be implemented. The “host” modem-router simply serves as repeater, that is to say that same conveys the signals between the “guest” router and the Internet network I, without modifying same.

Concerning Step 9, the stopping of the connection between the “guest” router and the “host” modem-router may be the element triggering the generation and transmission of the disconnection signal. Said stopping of the connection may, for example, occur when the “guest” router is unplugged from the mains socket providing the power supply thereof.

### Second Embodiment—Second Alternative Embodiment

In the system in FIG. 7, the connection between the “guest” router and the “host” modem-router is a wired connection, provided for example by an RJ45 or Ethernet cable 56, so that said “guest” router and said “host” modem-router communicate through said wired connection. In this case, the “guest” router does not need to connect to the “host” access point 42. Therefore, it is not necessary that the “guest” router knows the “host” private security key.

The logical identification process described previously in reference to FIG. 4 (Event 1-Event 11), may then be implemented directly. The connection phase described previously in reference to FIG. 8 (Event 100-Step 105) is not necessary.

Concerning Step 9, the unplugging of the cable 56 may be the element triggering the generation and transmission of the disconnection signal.

Regardless of whether in the first or second alternative of the second embodiment, the “guest” router being able to be the property of the guest, said latter may pre-parametrize said “guest” router. Said pre-parametrization consists, for example, in saving in the memory 51 of the “guest” router: the “guest” unique identifier, the name of the network, the “guest” private security key and optionally the other “guest” connection parameters. Said pre-parametrization may be performed in the dwelling of the guest, prior to his installation in the dwelling of the host. Said pre-parametrization may also be performed directly in the dwelling of the host, notably by using the secure removable media device 530. Nevertheless, other pre-parametrization methods are possible.

The guest may, for example, use a computer or a Smartphone (or another item of electronic equipment) that he connects in a wired (for example, with an Ethernet cable) or wireless (for example, by Wi-Fi) manner to the “guest” router. Said computer or said Smartphone is used as interface so that the guest manually enters his “guest” unique identifier, his “guest” private security key and optionally his other “guest” connection parameters. Said information thus input is saved in the memory 51 of the “guest” router.

In an alternative embodiment, the guest connects in a wired (for example, with an Ethernet cable) or wireless (for example, by Wi-Fi) manner the “guest” router to his native modem-router. In response to said connection, or in response to the activation of the dedicated key 55, all of the connection parameters saved in the “guest” native modem-router are copied in the memory 51 of the “guest” router.

Said pre-parametrization of the “guest” router, achieving the communication of the “guest” unique identifier with said “guest” router, corresponds to Event 1.

Regardless of the embodiment (first or second), for security reasons, it may be advantageous that the connections to the Internet network of “guest” equipment may be tracked and/or isolated from connections of “host” equipment. For this, advantageously the log of connections of the “guest” item of equipment that are performed through the “guest” router is saved. The “guest” router and/or the “host” modem-router may save in the respective memory thereof, all of the events affecting the “guest” access point. The log (or log file) contains said records that are preferably dated and classed in chronological order, so as to enable an analysis of the activity of the “guest” router. The log may be transmitted periodically or in real time via the Internet network, to the server S or to another server, for example a server managed by the Internet network access provider of the host.

Regardless of the embodiment (first or second), the host may authorize the guest to connect to the Internet network through the intermediary of the “guest” router, but with restrictive conditions. For example: connection limited over time (Internet session limited over a period of 1 day to 15 days, for example) and/or limited in terms of bandwidth. To this end, the host may, via the interface of a dedicated Internet site, tell the server S beforehand that he plans to rent his dwelling for a given period, and that the activation of the “guest” access point is only authorized for said period. The host may also give for instruction to the server S to only allocate a portion of his bandwidth to the “guest” access point. In Step 4, the server S may then integrate into the activation command at least one of the following parametrization data: duration of the activation of the “guest” access point, portion of bandwidth allocated to the “guest” access point. And during Event 6, the “guest” router is automatically parametrized with the item or items of parametrization data integrated into the activation command The host user may also receive one or more confirmation messages (email, sms, etc.) generated and transmitted by the server S. Said message may consist of a confirmation of the activation and/or of the use and/or of the deactivation of the “guest” access point 52. The host user may thus check the correct sequencing of each step of the process and track/secure the use that is made of the “guest” access point by the guest user.

The arrangement of the various elements and/or means and/or steps of the invention, in the embodiments described hereinabove, must not be understood as requiring such an arrangement in all of the implementations. In any case, it will be understood that various modifications can be made to said elements and/or means and/or steps, without deviating from the spirit and scope of the invention.

1.-14. (canceled)

15. A method for connecting equipment to the Internet network by using a modem-router, known as “host” modem-router, comprising a first access point, known as “host” access point, enabling at least one item of equipment paired to said “host” item of equipment, to connect to the Internet network with connection parameters, known as “host” connection parameters, specific to the user of the “host” item of equipment, said method comprising:
saving in a computer server accessible from the Internet network, a table wherein is stored a list of unique identifiers associated with users, which identifiers are associated with connection parameters specific to each user,
adding to the “host” modem-router a router, known as “guest” router, which “guest” router is provided with a second access point to the Internet network, known as “guest” access point, which “guest” access point is initially in a deactivated state, wherein that in order to connect at least one other item of equipment, known as “guest” item of equipment, to the Internet network, said method comprises subsequent steps of:
communicating to the “guest” router, a unique identifier, known as “guest” identifier, associated with a user of the “guest” item of equipment,
transmitting to the computer server, from the “guest” router, the “guest” identifier,
polling the table to verify that the “guest” identifier is stored in said table,
if the “guest” identifier is stored in the table: transmitting to the “guest” router, from the computer server:
an activation command of the “guest” access point, and
connection parameters, known as “guest” connection parameters, specific to
the user of said “guest” item of equipment and that are associated with the “guest” identifier in the table,
activating the “guest” access point following the receipt of the activation command by the “guest” router, and parametrizing said “guest” router with the “guest” connection parameters transmitted by the computer server,
pairing the “guest” item of equipment with the “guest” router, for the connection thereof to the Internet network through the “guest” access point and with the “guest” connection parameters,
saving the log of connections of the “guest” item of equipment performed through the “guest” router.

16. The method according to claim 15, further comprising:
moving the “guest” router away from the physical media device of the “host” modem-router and establishing a connection between said “guest” router and said modem-router so that said “host” modem-router acts as a repeater.

17. The method according to claim 16, further comprising:
establishing a wireless connection between the “guest” router and the “host” modem-router so that said “guest” router and said “host” modem-router communicate through the “host” access point.

18. The method according to claim 17, further comprising:
transmitting to the “guest” router a private security key associated with the “host” access point, known as “host” private security key, in order to authorize said “guest” router to communicate with the “host” modem-router through the “host” access point.

19. The method according to claim 16, further comprising:
establishing a wired connection between the “guest” router and the “host” modem-router so that said “guest” router and said “host” modem-router communicate through said wired connection.

20. The method according to claim 16, wherein the stopping of the connection between the “guest” router and the “host” modem-router results in the automatic implementation of a logical computer process leading to the deactivation of the “guest” access point.

21. The method according to claim 15, further comprising at least one of the following features:
the log of connections contains all of the events affecting the “guest” access point, which events are preferably dated and classed in chronological order, so as to enable an analysis of the activity of the “guest” router,
the log of connections is transmitted periodically or in real time, to the server or to another server, via the Internet network.

22. The method according to claim 15, further comprising:
integrating the “guest” router directly into the “host” modem-router.

23. The method according to claim 15, further comprising:
saving in a secure removable media device the “guest” unique identifier,
equipping the modem-router of a connection interface adapted to receive the secure removable media device.

24. The method according to claim 23, wherein the insertion of the secure removable media device into the connection interface results in the automatic transmission of the “guest” unique identifier to the computer server.

25. The method according to claim 23, wherein the withdrawal of the secure removable media device from the connection interface results in the automatic implementation of a logical computer process leading to the deactivation of the “guest” access point.

26. The method according to claim 23, further comprising:
saving in the secure removable media device, apart from the “guest” identifier, the “guest” connection parameters,
parametrizing the “guest” router with the “guest” connection parameters following the insertion of the secure removable media device into the connection interface, which parametrization is performed before, during or after the activation of the “guest” access point.

27. The method according to claim 15, further comprising:
saving in the computer server the log of connections of the “guest” item of equipment performed through the “guest” router.

28. The method according to claim 15, further comprising:
integrating into the activation command at least one of the following parametrization data: duration of the activation of the “guest” access point, portion of bandwidth allocated to the “guest” access point,
automatically parametrizing the “guest” router with the item or items of parametrization data integrated into the activation command.
